(19) United States
(12) Patent Application Publication
(10) Pub. No.: US 2003/0145227 A1
(43) Pub. Date: Jul. 31, 2003

(54) System and method of automatically handling internet key exchange traffic in a virtual private network

(75) Inventor: Edward B. Boden, Vestal, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/058,954

(22) Filed: Jan. 28, 2002

(51) Int. Cl. H04L 9/00

(52) U.S. Cl. 713/201; 713/171; 709/223

(57) ABSTRACT

A system and method for automatically handling Internet Key Exchange (IKE) traffic in a Virtual Private Network (VPN) is provided. Specifically, under the present invention, a VPN gateway node is first searched for IKE traffic permit filters. If none are found, IKE traffic is permitted to flow in and out of the VPN gateway node. The present invention also provides IKE traffic management so that outbound IKE traffic can be guided and secured in a proper fashion.

### BACKGROUND OF THE INVENTION

1. Field of the Invention

The present invention generally relates to a system and method for automatically handling Internet Key Exchange (IKE) traffic in a virtual private network (VPN). More particularly, the present invention provides a system and method that obviate the need for IKE traffic permit filters in a VPN.

2. Background Art

As the use of internal computer networks in the workplace becomes more prevalent, companies are increasingly seeking better ways to connect with outside sources. For example, a company may desire to form a business to business connection with another company. Alternatively, the company may wish to provide a way for its employees to access the internal network from an external source (e.g., a home computer). To accommodate these needs, many companies have implemented a virtual private network (VPN). VPNs are well known in the art and are private data networks that make use of the public telecommunication infrastructure, which can greatly reduce communication costs.

In general, security for VPNs is based upon IPSec protocols set forth by the Internet Engineering Task Force (IETF). In order for a VPN connection to be formed between, for example, an external computer and a VPN gateway, IPSec security associations, based upon IPSec protocols such as Authentication Header (AH) and/or Encapsulation Security Payload (ESP), must first be established. The security associations provide a way for two connected nodes to secure data being transferred therebetween. To establish the requisite security associations, IKE traffic must be exchanged between the external computer and the VPN gateway. Once the connection has been established, all communications passing through the connection will be protected using the established security associations.

Problems arise, however, when IKE traffic attempts to pass in and out of the VPN gateway. Specifically, most companies have a security policy that requires all traffic between two nodes to be protected in a connection using IPSec security associations. This is a problem for IKE traffic, which is used to establish the security associations for the connection in the first place. Accordingly, it is impossible for IKE traffic to be protected in a connection it has yet to establish. In previous systems, the solution for this was to manually write IKE traffic permit filters to allow IKE traffic to pass through the VPN gateway. However, manually writing IKE traffic permit filters is an extremely laborious and time consuming task. Specifically, IKE traffic permit filters must be written for each possible connection to the VPN. Given the expansive nature of many VPNs, an inordinate quantity of filters could be required. Moreover, filters must be revised or added each time the VPN topography changes.

An additional problem with existing systems is that lack of proper IKE traffic management. Specifically, if IKE traffic is not guided through the proper VPN connection, it may be discarded by the receiving node. This is especially problematic in the case of nested VPN connections having coincident local endpoints. In this connection type, a nested VPN connection between a remote node (e.g., home computer) and a VPN gateway is surrounded by an outer VPN connection between the remote node's gateway (e.g., ISP) and the VPN gateway. Since IKE traffic cannot travel in the connection to which it pertains, IKE traffic pertaining to the nested VPN connection must travel outside of the nested VPN connection yet inside of the outer VPN connection. Similarly, IKE traffic pertaining to the outer VPN connection must travel outside of both VPN connections. If IKE traffic outbound from the VPN fails to do this, it will be discarded by the receiving node (e.g., ISP or home computer).

In view of the foregoing, there exists a need for a system and method for automatically handling IKE traffic in a VPN. A need also exists for a system and method that obviates the need for IKE traffic permit filters. A further need exists for a system and method that can properly guide and send IKE traffic through different VPN connections.

### SUMMARY OF THE INVENTION

The present invention overcomes the disadvantages of existing art by providing a system and method for automatically handling IKE traffic in a VPN. Specifically, under the present invention, a node such as the VPN gateway will first be searched for IKE traffic permit filters. If such filters are not detected, then IKE traffic will be automatically allowed to flow in and out of the VPN gateway (subject to specific inbound filters). The present invention also manages IKE traffic so that it is guided and secured through the proper VPN connection.

According to a first aspect of the present invention, a system for automatically handling Internet Key Exchange (IKE) traffic in a virtual private network (VPN) is provided. The system comprises: (1) a filter detection system for searching for IKE traffic permit filters; (2) an IKE traffic enablement system for automatically allowing IKE traffic to flow if the IKE traffic permit filters are not detected; and (3) an IKE traffic management system for managing the IKE traffic through VPN connections.

According to a second aspect of the present invention, a system for automatically handling Internet Key Exchange (IKE) traffic in a virtual private network (VPN) is provided. The system comprises: (1) a filter detection system for searching for IKE traffic permit filters on a first node; (2) an IKE traffic enablement system for automatically allowing IKE traffic to flow between the first node and a second node if the IKE traffic permit filters are not detected; and (3) an IKE traffic management system for managing outbound IKE traffic from the first node to the second node, wherein the outbound IKE traffic is guided outside of a VPN connection between the first node and the second node.

According to a third aspect of the present invention, a method for automatically handling Internet Key Exchange (IKE) traffic in a virtual private network (VPN) is provided. The method comprises the steps of: (1) searching for IKE traffic permit filters on a first node; (2) automatically allowing IKE traffic to flow in and out of the first node if the IKE traffic permit filters are not detected; and (3) managing outbound IKE traffic from the first node, wherein the outbound IKE traffic is guided outside of a particular VPN connection to which it pertains.

According to a fourth aspect of the present invention, a method for automatically handling Internet Key Exchange (IKE) traffic in a virtual private network (VPN) is provided. The method comprises the steps of: (1) searching for IKE traffic permit filters on a first node; (2) automatically allowing IKE traffic to flow between the first node and a second node if the IKE traffic permit filters are not detected; and (3) establishing security associations between the first node and the second node for an outer VPN connection.

According to a fifth aspect of the present invention, a method for automatically handling Internet Key Exchange (IKE) traffic in a virtual private network (VPN) is provided. The method comprises the steps of: (1) searching for IKE traffic permit filters on a first node; (2) automatically allowing IKE traffic to flow between the first node and a second node if the IKE traffic permit filters are not detected; (3) establishing security associations between the first node and the second node for an outer VPN connection; (4) automatically allowing IKE traffic to flow between the first node and a remote node; (5) establishing security associations between the first node and the remote node for a nested VPN connection within the outer VPN connection; and (6) managing outbound IKE traffic from the first node, wherein the outbound IKE traffic pertaining to the outer VPN connection is guided outside of the outer VPN connection, and wherein the outbound IKE traffic pertaining to the nested VPN connection is guided outside of the nested VPN connection

According to a sixth aspect of the present invention, a program product stored on a recordable medium for automatically handling Internet Key Exchange (IKE) traffic in a virtual private network (VPN) is provided. When executed, the program product comprises: (1) program code configured to search for IKE traffic permit filters; (2) program code configured to automatically allow IKE traffic to flow if the IKE traffic permit filters are not detected; and (3) program code configured to manage the IKE traffic through VPN connections.

Therefore, the present invention provides a system and method for automatically handling IKE traffic in a VPN.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a box diagram of a VPN enterprise gateway having an IKE system in accordance with the present invention.

FIG. 2 depicts an exemplary VPN connection arrangement.

FIG. 3 depicts an exemplary table.

FIG. 4 depicts a logic flow chart for handling inbound VPN traffic.

FIG. 5 depicts a logic flow chart for handling outbound VPN traffic.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general the present invention provides a system and method for automatically handling Internet Key Exchange (IKE) traffic in a Virtual Private Network (VPN). Specifically, to form a connection with a VPN node, the present invention will first search for IKE traffic permit filters on the node. If no IKE traffic permit filters are present, IKE traffic will be automatically allowed to flow in and out of the node. This allowance of IKE traffic based upon the absence of IKE traffic permit filters is referred to herein as implicit IKE. The present invention also provides for IKE traffic management so that outbound IKE traffic (from the VPN node) is guided outside of the particular VPN connection to which it pertains. If the outbound IKE traffic is not guided through the proper VPN connection, it may be discarded by the receiving node. As used herein, the term node is intended to refer to any endpoint in a VPN connection. This can include, among other things, the VPN enterprise gateway, internal computer systems, external gateways, and external computer systems.

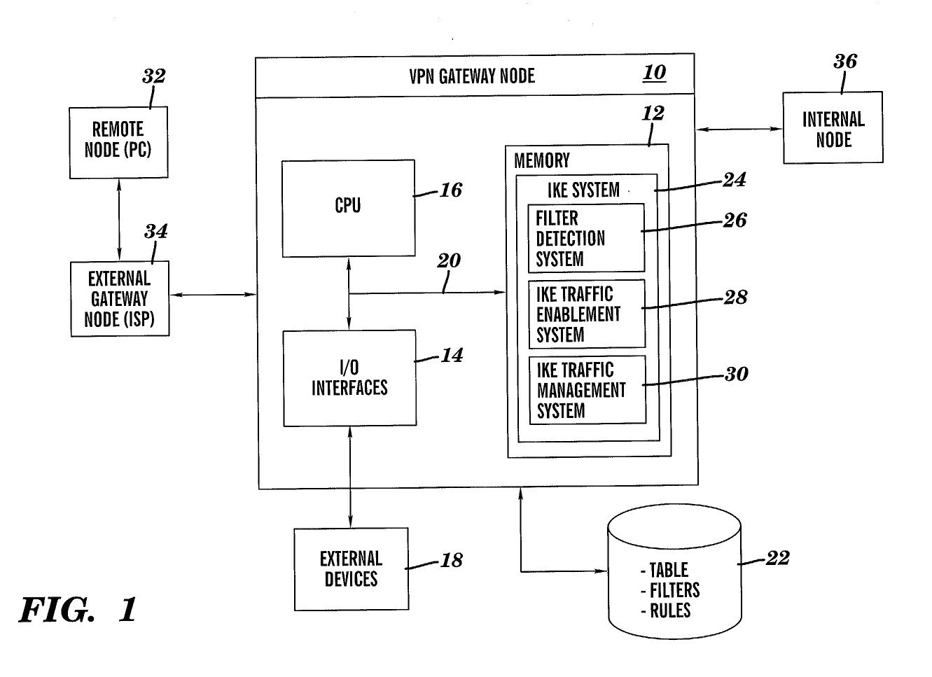

Referring now to FIG. 1, a computer system implementation of the present invention is shown. Specifically, the computer system shown in FIG. 1 is a VPN enterprise gateway (referred to herein as VPN gateway node 10). As depicted, VPN gateway node 10 generally comprises memory 12, input/output (I/O) interfaces 14, a central processing unit (CPU) 16, external devices/resources 18, bus 20, and database 22. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information to/from an external source. External devices 18 may comprise any known type of external device, including a CRT, LED screen, hand-held device, keyboard, mouse, voice recognition system, speech output system, printer, facsimile, pager, personal digital assistant, cellular phone, web phone, etc. Bus 20 provides a communication link between each of the components in the VPN gateway node 10 and likewise may comprise any known type of transmission link, including electrical, optical, wireless, etc. In addition, although not shown, additional components, such as cache memory, communication systems, system software, etc., may be incorporated into VPN gateway node 10.

Database 22 could provide storage for information necessary to carry out the present invention. Such information could include, among other things, a table that identifies: (1) VPN connections; (2) IP addresses of connected nodes, (3) security associations between connected nodes; and (4) any relationships between the VPN connections. Database 22 may include one or more storage devices, such as a magnetic disk drive or an optical disk drive. In another preferred embodiment database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

Stored in memory 12 is IKE system 24. As shown, IKE system 24 includes filter detection system 26, IKE traffic enablement system 28, and IKE traffic management system 30. As indicated above, many companies establish VPNs with security policies that requires all communications between a VPN node (e.g., VPN gateway node 10 or internal node 36) and an external node (e.g., remote node 32 or external gateway node 34) to be secured using IPSec security associations. This is so that once a connection is formed, all communications flowing between the external node and VPN node are protected using the established security associations. However, in order for the security associations to be established, IKE traffic must be exchanged between the VPN node and the external node. Thus, it is impossible to secure the IKE traffic using security associations that have yet to be established. As known in the art, security associations define how data is secured. For example, a security association may set forth, among other things, a key for encrypting/decrypting the data.

In previous systems, the solution was to manually write filters that permit IKE traffic to pass. Such a task, however, is often a laborious and error-prone task, particularly for a number of VPN connections such as nested connections and nested confections with coincident local endpoints. The present invention obviates the need for such filters. Specifically, under the present invention, filter detection system 26 first searches VPN gateway node 10 for IKE traffic permit filters. If no such filters are detected, IKE traffic enablement system 28 will allow VPN gateway node 10 to send and receive IKE traffic freely (subject to any limiting inbound filters in place). In a typical embodiment, filter detection system 26 will be run every time rules are loaded or uploaded to VPN gateway node 10. If IKE traffic permit filters are not detected, IKE traffic enablement system 28 will automatically allow IKE traffic to pass. Conversely, if IKE traffic permit filters are detected, IKE traffic will be handled according to the rules and filters of VPN gateway node 10. This allows system administrators of the VPN to choose whether to handle IKE traffic explicitly with manually written filters, or to allow the system to automatically handle IKE traffic.

As known in the art, an IKE traffic permit filter is a filter rule for UDP packets with action to ‘permit’ either the source port or destination port (or both). The filter rule direction, source IP, and destination IP can be any valid value. Accordingly, an IKE permit filter logically appears as follows:

filter set=<any valid set name> direction=* action=permit protocol=UDP

| | |
|---|---|
| source IP=* | destination IP=* |
| source port=500 | best port=500 |

It should be appreciated that this illustration is exemplary only and not intended to be limiting. For example, both ports need not be “500”. Rather, only one of the ports could be “500.”

IKE traffic management system 30 manages outbound IKE traffic from VPN gateway node 10. Specifically, when IKE traffic is sent from VPN gateway node 10 to an external node 32 or 34, it must be guided and secured in a proper fashion. This will be described in more detail below, but in general, IKE traffic pertaining to a particular VPN connection must be guided outside of the particular VPN connection. If this is not done, the IKE traffic could be discarded by the receiving external node 32 or 34. To ensure that all outgoing IKE traffic is guided in the proper VPN connection and secured according to the proper security association (if necessary), IKE traffic management system 30 maintains and references a table.

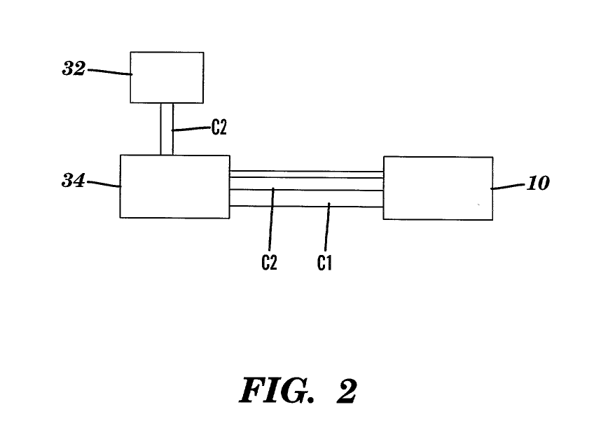

It should be understood that many types of VPN connections are known in the art and that not all connection types will be described herein. The present invention is intended to apply to any VPN connection between external nodes 32 and 34 and VPN nodes 10 and 36. Referring now to FIG. 2, a nested VPN connection with coincident local endpoints is depicted. Specifically, FIG. 2 depicts an outer VPN connection C1 between external gateway node 34 and VPN gateway node 10 as well as nested VPN connection C2 between remote node 32 and VPN gateway node 10. It should be understood that the VPN connections shown in FIG. 2 are for all traffic between the respective connection endpoints. Specifically, connections C1 and C2 are specified with: protocol=* (any); and source port=destination port=*(any).

To form the connections shown in FIG. 2, connection C1 must be formed first. That is, IKE traffic must be passed between external gateway node 34 and VPN gateway node 10. Although this IKE traffic cannot be secured according to IPSec security associations (since the IKE traffic is for establishing the security associations in the first place), it can still be privately secured by nodes 34 and 10. Thus, some level of security is provided for the initial IKE traffic. As explained above, before the initial IKE traffic is sent from external gateway node 34 to VPN gateway node 10, the filter detection system 26 searched for IKE traffic permit filters on VPN gateway node 10. If no IKE traffic permit filters were found, IKE traffic will be automatically permitted to flow in and out of VPN gateway node 10. This capability is provided by IKE traffic enablement system 28 in the form of logic in the operating system kernel of VPN gateway node 10. Specifically, the lack of IKE traffic permit filters on VPN gateway node 10 effectively causes a “switch” to be flipped “on” so that IKE traffic can automatically flow in and out of VPN gateway node 10. For the purposes of the present invention this is referred to as “implicit IKE.” Conversely, if IKE traffic permit filters were detected, IKE traffic enablement system 28 will ensure that “implicit IKE” is off so that existing filters are not circumvented.

Optionally, any inbound IKE traffic to VPN gateway node 10 can be filtered with an inbound filter (e.g., with “discard” action) while implicit IKE is on. This allows the system administrator to have finer-grained control of IKE traffic if they so desire, while benefitting from implicit IKE. In addition, the present invention can also optionally check the source IP address for any outbound traffic from VPN gateway node 10. This function can be performed by IKE traffic management system 30 to ensure that the outbound traffic originated from VPN gateway node 10. This ensures that outbound IKE traffic originates on VPN gateway node 10, and is not forwarded IKE traffic.

In either event, IKE communications will continue until security associations have been established between nodes 34 and 10. Under the present invention, the security associations are established according to IPSE protocols such as Authentication Header (AH) and Encapsulation Security Payload (ESP). As known in the art, there are a total of four security associations for a single connection between two nodes. Two security associations define the security protocols for inbound and outbound traffic for one node, while another two security associations define the security protocols for inbound and outbound traffic for the second node.

Once the security associations between external gateway node 34 and VPN gateway node 10 have been established, connection C1 is formed/loaded. Thereinafter, all non-IKE traffic between external gateway node 34 and VPN gateway node 10 will be guided through connection C1 and secured according to the security associations therefor. Conversely, any IKE traffic (e.g., refresh IKE traffic) that is later exchanged between external gateway node 34 and VPN gateway node 10 that pertains to connection C1 will be guided outside of connection C1 and will not be secured according to the security associations (only privately between nodes 34 and 10).

After connection C1 has been formed, connection C2 between remote node 32 and VPN gateway node 10 can be formed in a similar manner. Specifically, if no IKE traffic permit filters were detected on VPN gateway node 10, the IKE traffic between remote node 32 and VPN gateway node 10 will be automatically allowed to flow inside connection C1. Once remote node 32 and gateway node 10 have established their four security associations, connection C2 is formed. Thereafter, all non-IKE traffic between nodes 32 and 10 will flow through connection C2 and be secured according to C2 security associations. Conversely, any future IKE traffic pertaining to connection C2 will be guided outside of connection C2 (i.e., through connection C1). The IKE traffic in this instance will be secured both privately by nodes 32 and 10 as well as according to the security associations for connection C1. It should be appreciated that the IKE communications between nodes 32 and 10 can be made subject to the same optional filter and source IP address checking that is described above for communications between nodes 34 and 10.

The proper routing and securing of IKE traffic are functions performed by IKE traffic management system 30. In previous systems, a connection arrangement such as that depicted in FIG. 2 posed numerous problems. Specifically, outbound IKE traffic from VPN gateway node 10 was often guided through an improper connection and/or was not secured in a proper manner. This was especially problematic for refreshing IKE traffic. Specifically, the security associations between two connected nodes could be periodically refreshed to maintain security. However, if an external node receives IKE traffic through the wrong connection, or receives only a piece of an IKE traffic through a proper connection, the receiving node may discard the entire traffic. For example, if external gateway node 34 received refreshing IKE traffic for connection C1 from VPN gateway node 10 through connection C1, the traffic would likely be dropped since IKE traffic should never be guided through the connection to which it pertains. Having a nested VPN connection with coincident local endpoints often “confuses” the VPN gateway node 10 into routing IKE traffic improperly.

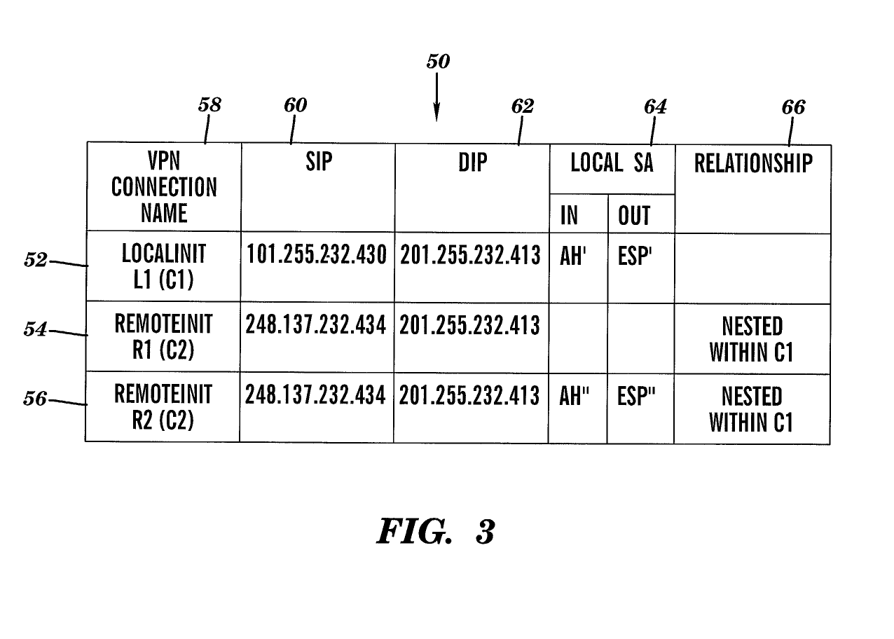

To properly secure and guide outbound IKE traffic, IKE traffic management system 30 maintains a table 50 such as that shown in FIG. 3. Table 50 contains entries 52, 54, and 56 that identify VPN connection (names) 58, source IP addresses 60, destination IP addresses 62, local security associations 64, and relationships between connections 66. When a connection such as C1 is formed, an active entry such as entry 52 is created. As shown, the VPN connection name 58 for entry 52 is LOCALINIT L1, the source IP address 60 (i.e., IP address of external gateway node 34) is 101.255.232.430, and the destination IP address (i.e., IP address of VPN gateway node 10) is 201.255.232.413. It should be understood that the source and destination IP addresses 60 and 62 are those of the VPN connection endpoints (i.e., the IP addresses of the IKE nodes). The local security associations 64 for IKE traffic for external gateway node 34 are based upon the AH protocol for inbound IKE traffic and the ESP protocol for outbound IKE traffic. As explained above, AH and ESP are well known IPSec protocols. Each resulting security association identified in table 50 defines how the relevant IKE traffic is secured. Accordingly, although not shown in table 50 for brevity purposes, each security association includes, among other things, a key for encrypting/decrypting the IKE traffic.

When VPN gateway node 10 receives IKE traffic through connection C1, it recognizes this as an attempt to create nested VPN connection C2. This is because, as indicated above, IKE traffic cannot travel through a connection to which it pertains. Accordingly, any IKE traffic received through connection C1 will be assumed not to pertain to connection C1, but rather, a new connection within connection C1. Upon receiving IKE traffic through connection C1, IKE traffic management system 30 will create pending connection entry 54 in table 50. As depicted, entry 54 indicates the VPN connection name 58 of REMOTEINIT R1, source IP address 60 (i.e., IP address of remote node 32) of 248.137.232.434, and destination IP address 62 (i.e., IP address of VPN gateway node 10) of 201.255.232.413. However, since connection C2 is only pending at this point, no security associations have been established. Relationship 66 indicates that connection C2 is nested within connection C1.

Once VPN gateway node 10 and remote node 32 have completed negotiations and established security associations, connection C2 can be loaded.

Once loaded, pending entry 54 can either be replaced by or supplemented by active entry 56. Specifically, entry 56 contains the same information as pending entry 54, however, it identifies local security associations 64 that have been established between remote node 32 and VPN gateway node 10.

Once the table 50 is complete, it can be referred to by IKE traffic management system 30 in properly routing and securing further IKE traffic. For example, if refresh IKE traffic for connection C2 is received by VPN gateway node 10 through connection C1, IKE traffic management system 30 will reference table 50. Using either the source/destination IP address of the received IKE traffic, or the connection name through which the IKE traffic traveled, IKE traffic management system can cross-reference table 50 to properly guide and secure response IKE traffic through the proper connection. For example, by searching for the source and destination IP addresses identified in the inbound IKE traffic, it will be revealed that the communication pertains to the existing C2 connection (REMOTEINIT R2) between nodes 32 and 10. Since the IKE traffic pertains to connection C2, IKE traffic management system 30 will guide the response IKE traffic outside of connection C2 in the proper security format. Specifically, the response communication will be guided through connection C1 according to the security associations defined for connection C1 in entry 52.

It should be understood that IKE traffic pertaining to connection C2 will be secured both privately by nodes 32 and 10 as well as according to the security associations identified in entry 52. Accordingly, IKE traffic pertaining to connection C2 has a double layer of security. Conversely, because IKE traffic pertaining to connection C1 must travel outside of connection C1, no IPSec based security can be provided. Rather, such IKE traffic is secured only by nodes 34 and 10. It should also be understood that table 50 is intended to be exemplary only and other equivalent variations could be implemented.

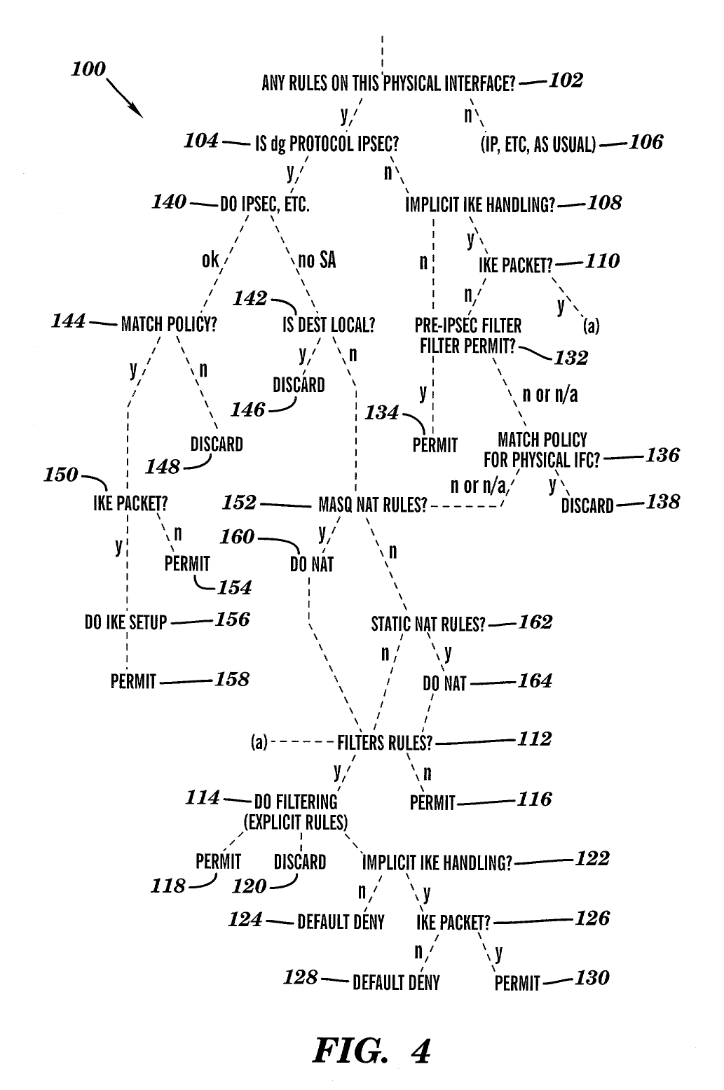

FIG. 4 depicts an exemplary flow chart 100 of the manner in which VPN gateway node 10 would handle an inbound communication. First, when a communication is received, it would be determined whether there are any rules on the interface 102. If no rules are present, the communication would be handled as usual 106. If rules are present, it would then be determined whether the datagram is secured according to IPSec protocols 104. If the communication is not secured according to IPSec protocols, it would be determined if implicit IKE has been enabled 108. Specifically, it would be determined if IKE traffic enablement system 28 has enabled IKE traffic to pass due to the lack of IKE traffic permit filters detected by filter detection system 26. If implicit IKE has been enabled, and the communication is an IKE packet 110, the system would be searched for any filter rules 112. If none are found, the communication would be permitted 116. If filter rules are found, filtering of the communication would be performed 114. Based upon the filtering, the communication can either be permitted 118 or discarded 120. Moreover, based upon the filtering, it could be determined again whether implicit IKE has been enabled 122. If not, the communication would be default denied 124. If implicit IKE has been enabled, and the communication is an IKE communication 126, then it would be permitted 130. Conversely, if it is not an IKE communication, the communication would be default denied 128.

If at step 108, it was determined that implicit IKE has not been enabled, or the communication was found not to be an IKE packet at step 110, it would be determined whether a pre-IPSec filter permits the communication 132. If so, the communication would be permitted 134. If not, it would be determined whether the communication matches the policy for the physical IFC (interface). If so, the communication would be discarded 138.

If at step 104, it is determined that the datagram is an IPSec protocol, an IPSec decapsulation operation would be attempted 140. If successful, it would be determined whether the communication matched existing policy 144. If not, the communication would be discarded 148. If the communication matched policy, it would be determined whether the communication is an IKE packet 150. If not, the communication would be permitted 154. If it is an IKE packet, an IKE setup operation would be performed 156, followed by permitting the communication 158. The IKE setup operation is part of the IKE traffic management system 30 (FIG. 1) and creates an entry (e.g., entry 54) in table 50.

If at step 140 no security associations were present, it would be determined whether the destination of the communication is local 142. If the destination is local, the communication would be discarded 146. If the destination is not local, or at step 136 it was determined that the communication does not match the policy for the physical interface, the system would determine whether there are any masquerade Network Address Translation (NAT) rules. If so, a masquerade NAT operation would be performed 160 and the communication would be handled as described above in conjunction with steps 112-130. If there are no masquerade NAT rules, it would be determined whether there are any static NAT rules 162. If not, the communication would be handled as describe above in conjunction with steps 112-130. If there are static NAT rules, a static NAT operation would be performed 164, and the communication would be handled as described above in conjunction with steps 112-130.

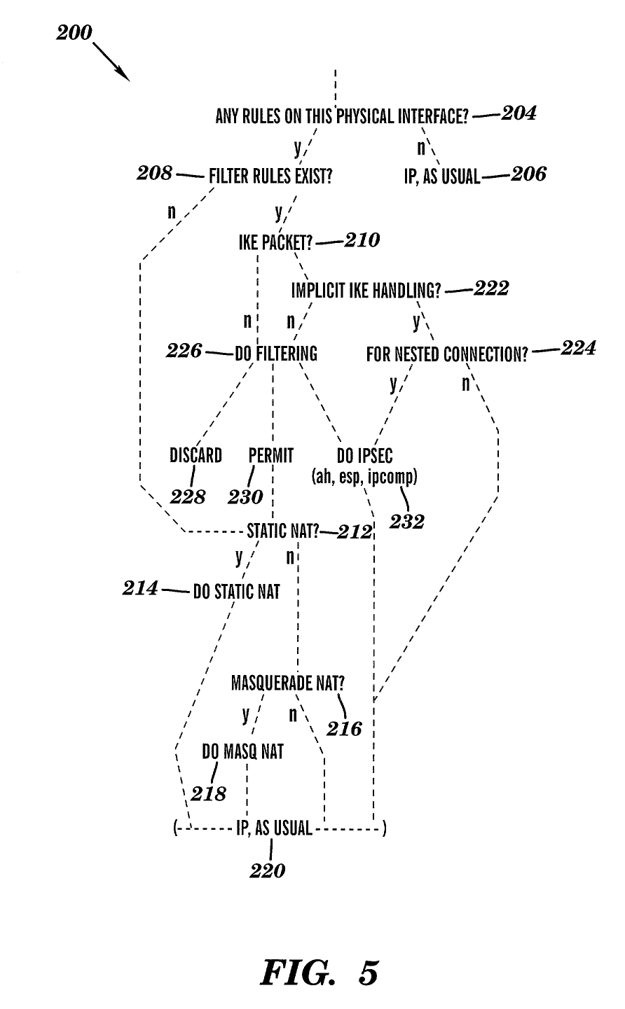

Referring now to FIG. 5, an exemplary flow chart 200 depicting the manner in which an outbound communication would be handled is shown. When a communication is sent out from VPN gateway node, it would first be determined whether any filter rules are present 204. If no such rules are present, the communication would be allowed to proceed as usual 206. If rules are present, it would be determined whether any filter rules exist 208. If no filter rules exist, it would be determined whether there are any static NAT rules 212. If so, a static NAT operation would be performed 214 and the communication would proceed as usual 220. If no static NAT rules are present, it would then be determined whether there are any masquerade NAT rules 216. If not, the communication would proceed as usual 220. If there are masquerade NAT rules, a masquerade NAT operation would be performed 218 and the communication would proceed as usual 220.

If at step 208 it was determined that filter rules exist, the communication would be examined to determine if it is an IKE packet 210. If it is, a determination would be made as to whether implicit IKE is enabled 222. That is, are no IKE traffic permit filters present such that IKE traffic enablement system 28 permitted IKE traffic to flow. If implicit IKE is enabled, it would be determined whether the corresponding connection is a nested connection 224. If the connection is nested, then an IPSec security operation would be performed according to the proper security associations and the communication would be passed through the appropriate connection. If the connection is not nested, the communication would proceed as usual 220.

If it was determined that implicit IKE is not enabled at step 222 or the communication is not an IKE communication at step 210, a filtering operation would be performed 226 according to the filters stored on the system. The filtering could result in either permitting the communication 230, discarding the communication 228, or performing an IPSec encapsulation operation 232 followed by transmission of the communication as usual. If the communication is permitted, it would then be subject to the static and masquerade NAT steps 212-218 before transmission as usual 220.

It is understood that the present invention can be realized in hardware, software, or a combination of hardware and software. Moreover, VPN gateway node 10 according to the present invention can be realized in a centralized fashion in a single computerized workstation, or in a distributed fashion where different elements are spread across several interconnected systems (e.g., a network). Any kind of computer/server system(s)—or other apparatus adapted for carrying out the methods described herein—is suited. A typical combination of hardware and software could be a general purpose computer system with a computer program that, when loaded and executed, controls VPN gateway node 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the present invention is not limited to implementation on a VPN enterprise gateway. Rather, the present invention could be implemented on any VPN system.

1. A system for automatically handling Internet Key Exchange (IKE) traffic in a virtual private network (VPN), comprising:
a filter detection system for searching for IKE traffic permit filters;
an IKE traffic enablement system for automatically allowing IKE traffic to flow if the IKE traffic permit filters are not detected; and
an IKE traffic management system for managing the IKE traffic through VPN connections.

2. The system of claim 1, wherein the filter detection system searches for IKE traffic permit filters on a first node.

3. The system of claim 2, wherein the IKE traffic enablement system automatically allows IKE traffic to flow between the first node and a second node if IKE traffic permit filters are not detected by the filter detection system.

4. The system of claim 3, wherein the IKE traffic that flows between the first node and the second node establishes security associations for a VPN connection between the first node and the second node.

5. The system of claim 4, wherein the IKE traffic enablement system automatically allows refreshing IKE traffic to flow between the first node and the second node, and wherein the refreshing IKE traffic is guided outside of the VPN connection by the IKE traffic management system.

6. The system of claim 5, wherein the refreshing IKE traffic is secured by the first node and the second node.

7. The system of claim 1, wherein the IKE traffic management system references a table containing entries that identify connections between nodes, IP addresses of connected nodes, and security associations for the VPN connections.

8. The system of claim 7, wherein the IKE traffic management system guides IKE traffic pertaining to a nested VPN connection outside of the nested VPN connection in a secured mode based upon the security associations between the first node and the second node identified in the table.

9. A system for automatically handling Internet Key Exchange (IKE) traffic in a virtual private network (VPN), comprising:
a filter detection system for searching for IKE traffic permit filters on a first node; an IKE traffic enablement system for automatically allowing IKE traffic to flow between the first node and a second node if the IKE traffic permit filters are not detected; and
an IKE traffic management system for managing outbound IKE traffic from the first node to the second node, wherein the outbound IKE traffic is guided outside of a VPN connection between the first node and the second node.

10. The system of claim 9, wherein the IKE traffic between the first node and the second node establishes security associations for an outer VPN connection.

11. The system of claim 9, wherein the IKE traffic enablement system further automatically allows IKE traffic to flow between the first node and a remote node to establish security associations for a nested VPN connection between the first node and the remote node.

12. The system of claim 11, wherein refresh IKE traffic between the first node and the remote node flows outside of the nested VPN connection.

13. The system of claim 9, wherein the IKE traffic management system references a table to determine a proper connection through which the outbound IKE traffic from the first gateway node should be guided, and wherein the table contains entries that identify VPN connections between nodes, IP address of connected nodes, and security associations for the VPN connections.

14. A method for automatically handling Internet Key Exchange (IKE) traffic in a virtual private network (VPN), comprising the steps of:
searching for IKE traffic permit filters on a first node;
automatically allowing IKE traffic to flow in and out of the first node if the IKE traffic permit filters are not detected; and
managing outbound IKE traffic from the first node, wherein the outbound IKE traffic is guided outside of a particular VPN connection to which it pertains.

15. The method of claim 14, wherein managing step comprises the steps of:
accessing a table to identify the particular VPN connection to which the outbound IKE traffic pertains; and
routing the IKE traffic outside of the identified VPN connection.

16. The method of claim 15, further comprising the step of securing the IKE traffic flowing in and out of the first node.

17. A method for automatically handling Internet Key Exchange (IKE) traffic in a virtual private network (VPN), comprising the steps of:
searching for IKE traffic permit filters on a first node;
automatically allowing IKE traffic to flow between the first node and a second node if the IKE traffic permit filters are not detected; and
establishing security associations between the first node and the second node for an outer VPN connection.

18. The method of claim 17, further comprising the step of managing outbound IKE traffic from the first node, wherein the outbound IKE traffic pertaining to the outer VPN connection is guided outside of the outer VPN connection, and wherein the outbound IKE traffic pertaining to a nested VPN connection between the first node and a remote node is guided outside of the nested VPN connection.

19. The method of claim 18, wherein the managing step comprises the steps of:
referencing a table that identifies VPN connections between nodes, IP addresses of connected nodes, and security associations for the VPN connections;
routing the outbound IKE traffic pertaining to the outer VPN connection outside of the outer VPN connection; and
routing the outbound IKE traffic pertaining to the nested VPN connection outside of the nested VPN connection.

20. A method for automatically handling Internet Key Exchange (IKE) traffic in a virtual private network (VPN), comprising the steps of:
searching for IKE traffic permit filters on a first node;
automatically allowing IKE traffic to flow between the first node and a second node if the IKE traffic permit filters are not detected;
establishing security associations between the first node and the second node for an outer VPN connection;
automatically allowing IKE traffic to flow between the first node and a remote node;
establishing security associations between the first node and the remote node for a nested VPN connection within the outer VPN connection; and
managing outbound IKE traffic from the first node, wherein the outbound IKE traffic pertaining to the outer VPN connection is guided outside of the outer VPN connection, and wherein the outbound IKE traffic pertaining to the nested VPN connection is guided outside of the nested VPN connection.

21. The method of claim 20, further comprising the step of securing the IKE traffic between the first node and the remote node based upon the security associations established between the first node and the second node.

22. The method of claim 20, wherein the managing step comprises the steps of:
referencing a table that identifies VPN connections, IP addresses of connected nodes, and security associations for the VPN connections;
routing the outbound IKE traffic from the first node to the second node outside of the outer VPN connection; and
routing the outbound IKE traffic from the first node to the remote node outside of the nested VPN connection in a secured mode based upon the security associations between the first node and the second node identified in the table.

23. The method of claim 20, further comprising the steps of:
receiving an inbound IKE communication in the first node from the remote node through the outer VPN connection;
creating a potential nested VPN connection entry in a table, wherein the entry identifies a potential nested VPN connection and IP addresses corresponding to the remote node and the first node;
negotiating security associations between the remote node and the first node;
loading the nested VPN connection between the remote node and the first node; and
updating the table by replacing the potential VPN connection with the nested VPN connection.

24. A program product stored on a recordable medium for automatically handling Internet Key Exchange (IKE) traffic in a virtual private network (VPN), which when executed, comprises:
program code configured to search for IKE traffic permit filters;
program code configured to automatically allow IKE traffic to flow if the IKE traffic permit filters are not detected; and
program code configured to manage the IKE traffic through VPN connections.

25. The program product of claim 24, wherein the IKE traffic permit filters are searched for on a first node.

26. The program product of claim 25, wherein the IKE traffic is automatically allowed to flow between the first node and a second node if IKE traffic permit filters are not detected.

27. The program product of claim 26, wherein the IKE traffic that flows between the first node and the second node establishes security associations for a VPN connection between the first node and the second node.

28. The program product of claim 27, wherein IKE refreshing traffic is automatically allowed to flow between the first node and the second node outside of the VPN connection.

29. The program product of claim 28, wherein the refreshing IKE traffic is secured by the first node and the second node.

30. The program product of claim 24, wherein the IKE traffic for VPN connections is managed based upon a table containing entries that identify connections between nodes, IP addresses of connected nodes, and security associations for the VPN connections.

31. The program product of claim 30, wherein the IKE traffic pertaining to a nested VPN connection is guided outside of the nested VPN connection in a secured mode based upon the security associations between the first node and the second node identified in the table.
